(19) United States
(12) Patent Application Publication
(10) Pub. No.: US 2008/0183623 A1
(43) Pub. Date: Jul. 31, 2008

(54) Secure Provisioning with Time Synchronization

(76) Inventors: Zhangwei Xu, Redmond, WA (US); Josh Benaloh, Redmond, WA (US); Martin H. Hall, Sammamish, WA (US); David Jaroslav Sebesta, Redmond, WA (US); Jeffrey Alan Herold, Bellevue, WA (US); Zeyong Xu, Issaquah, WA (US); Douglas Reed Beck, Seattle, WA (US); Curt Andrew Steeb, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(21) Appl. No.: 11/668,439

(22) Filed: Jan. 29, 2007

(51) Int. Cl. H04L 9/00

(52) U.S. Cl. 705/51; 705/418

(57) ABSTRACT

A pay-per-use business model relies on an accurate, or at least, un-tampered, time reference for the administration of prepaid usage time, e.g. hours, or subscription expiration dates. A protocol for provisioning usage requires that any electronic device request for provisioning includes current time at the device. A server responding to the request may evaluate the time at the device and send an updated time when the current time at the device is outside a variance limit. If the electronic device repeatedly sends requests with inaccurate time, the server may cease sending time updates and block the electronic device from further updates for suspected tampering.

### BACKGROUND

Pay-as-you go or pay-per-use business models have been used in many areas of commerce, from cellular telephones to commercial laundromats. In developing a pay-as-you go business, a provider, for example, a cellular telephone provider, offers the use of hardware (a cellular telephone) at a lower-than-market cost in exchange for a commitment to remain a subscriber to their network for a period of time. In this specific example, the customer receives a cellular phone for little or no money in exchange for signing a contract to become a subscriber for a given period of time. Over the course of the contract, the service provider recovers the cost of the hardware by charging the consumer for using the cellular phone.

The pay-as-you-go business model is predicated on the concept that the hardware provided has little or no value, or use, if disconnected from the service provider. To illustrate, should the subscriber mentioned above cease to pay his or her bill, the service provider deactivates the account, and while the cellular telephone may power up, calls cannot be made because the service provider will not allow them. The deactivated phone has no “salvage” value, because the phone will not work elsewhere and the component parts are not easily salvaged nor do they have a significant street value. In most cases, however, even though the phone has been deactivated it is still capable of connecting to the service provider in order to arrange restoration of the account. When the account is brought current, the service provider will re-authorize the device on its network and allow calling.

This model works well when the service provider, or other entity taking the financial risk of providing subsidized hardware, is able to enforce the terms of the contract as above. Because an electronic device, such as a computer, may have useful functions even when not connected to a network or server, a pay-per-use device may be responsible to self-administer contract enforcement. When the electronic device is responsible for self administration, a clock circuit may become a prime target for tampering because many business models are time based. For example, a subscription good for one calendar month may never expire if the clock is tampered with to keep the time within the valid month.

### SUMMARY

A system supporting pay-per-use electronic devices requires that all communication from the electronic device include the current time at the electronic device initiating the communication. The communication may be a request to add value to a timed usage or subscription account. If the current time at the electronic device is not within allowable limit, a response may include an updated time. The original request may be deferred or denied until the electronic device communicates a message with an acceptable current time. If repeated communications from the electronic device contain invalid current times, the electronic device in question may be blocked from being sent further responses until an appropriate service action may be taken to determine if tampering or a hardware failure have occurred.

If the current time at the electronic device is within the allowable limit, processing may proceed normally. To discourage fraudulent messages, application-level security may be applied to communications by encrypting and signing messages between a secure module in the electronic device and a trusted server.

### BRIEF DESCRIPTION OF THE DRAWINGS

FIG. 1 is a block diagram of a logical view of a computer;

FIG. 2 is a simplified and exemplary block diagram of a system supporting a pay-per-use and subscription business model;

FIG. 3 is a simplified and representative block diagram of a provisioning server;

FIG. 4 is an exemplary packet format for an authentication ticket;

FIG. 5 is flow chart depicting an exemplary method of building and sending an authentication ticket;

FIG. 6 is an exemplary method of processing an authentication ticket at a provisioning server; and

FIG. 7 is an exemplary method of processing a response to an authentication ticket at a metered-use device.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the ten ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

Many prior-art high-value computers, personal digital assistants, organizers, and the like, are not suitable for use in a pre-pay or pay-for-use business model as is. The ability to enforce a contract requires a service provider, or other enforcement entity, to be able to affect a device's operation even though the device may not be connected to the service provider, e.g. connected to the Internet. A first stage of enforcement may include a simple pop up warning, indicating the terms of the contract are nearing a critical point. A second stage of enforcement, for example, after pay-per-use minutes have expired or a subscription period has lapsed, may be to present a system modal user interface for adding value and restoring service. A provider's ultimate leverage for enforcing the terms of a subscription or pay-as-you go agreement is to disable the device. Such a dramatic step may be appropriate when it appears that the user has made a deliberate attempt to subvert the metering or other security systems active in the device.

Uses for the ability to place an electronic device into a limited function mode may extend beyond subscription and pay-per-use applications. For example, techniques for capacity consumption could be used for licensing enforcement of an operating system or individual applications.

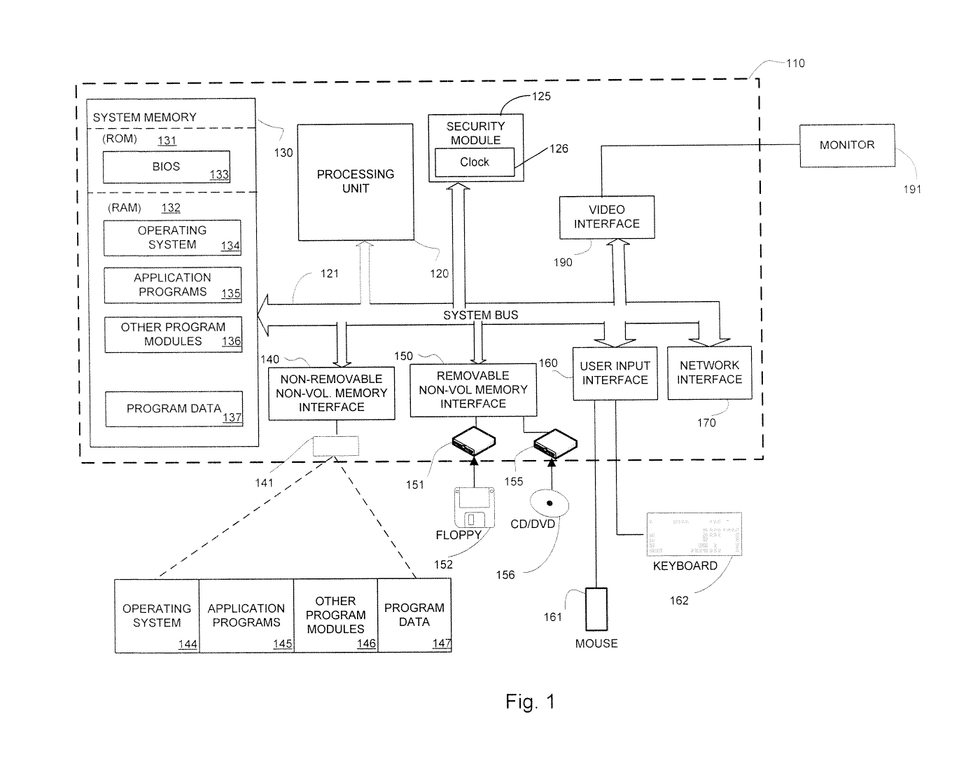

FIG. 1 illustrates a logical view of a computing device in the form of a computer 110 that may be used in a pay-per-use or subscription mode. For the sake of illustration, the computer 110 is used to illustrate the principles of the instant disclosure. However, such principles apply equally to other electronic devices, including, but not limited to, cellular telephones, personal digital assistants, media players, appliances, gaming systems, entertainment systems, set top boxes, and automotive dashboard electronics, to name a few. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, front side bus, and Hypertransport™ bus, a variable width bus using a packet data protocol.

The computer 10 may include a security module 125. The security module 125 may be enabled to perform security monitoring, pay-per-use and subscription usage management, and policy enforcement related to terms and conditions associated with paid use, particularly in a subsidized purchase business model. The security module 125 may be embodied in the processing unit 120, as a standalone component, or in a hybrid, such as a multi-chip module. A clock 126 may be incorporated into the security module 125 to help ensure tamper resistance. To allow user management of local time setting, including daylight savings or movement between time zones, the clock 126 may maintain its time in a coordinated universal time (UTC) format and user time calculated using a user-settable offset. The security module 125 may also include a cryptographic function (not depicted).

Computer 110 typically includes a variety of Computer readable media, Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, digital camera, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190.

The computer 110 may operate in a networked environment using logical connections to one or more remote computers (not depicted) over a network interface 170, such as broadband Ethernet connection or other known network.

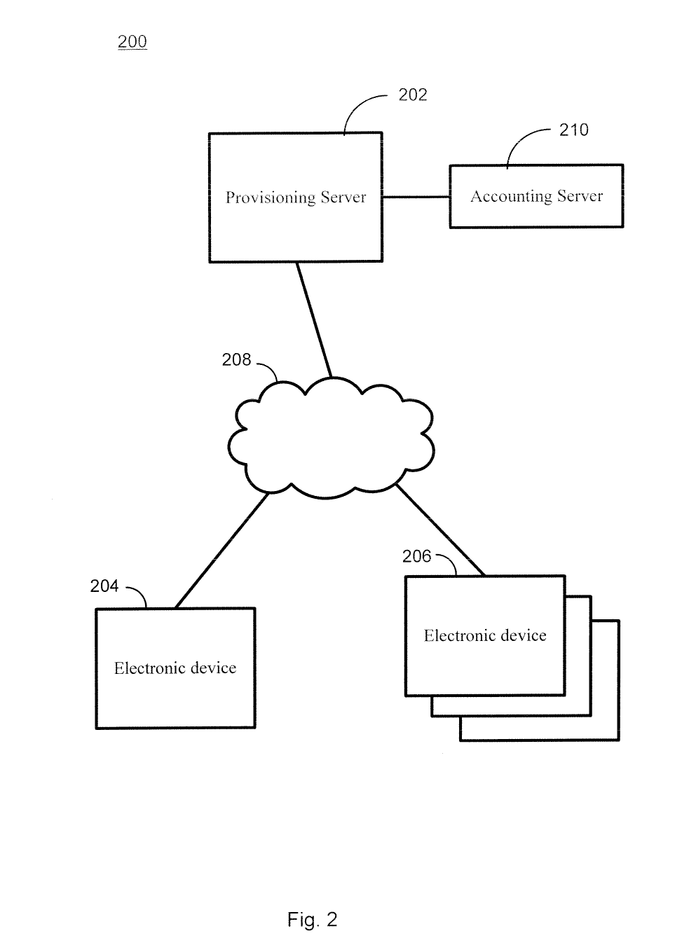

FIG. 2 is a simplified and exemplary block diagram of a system 200 supporting pay-per-use and subscription usage of a computer or other electronic device. A provisioning server 202 may serve as a trusted endpoint for provisioning requests from one or more electronic devices participating in the pay-per-use business ecosystem. One electronic device 204 may be similar to the computer 110 of FIG. 1. Other electronic devices 206 may perform substantially the same as the exemplary device 204. Communication between the provisioning server 202 and the electronic device 204 may be accomplished through a network 208 that may include landline, wireless, or broadband networks, or other networks known in the art,

An accounting server 210 may be linked to the provisioning server 202 and may maintain account data corresponding to the electronic device 204. The accounting server 210 may also serve as a clearinghouse for financial transactions related to the electronic device 204, such as, replenishing or adding value to a nay-per-use account maintained on the electronic device 204. For example, an end-user may transfer funds to an account maintained on the accounting server 210 for use in an add-value transaction. The accounting sever 210 itself may have a link to a scratch card system (not depicted) allowing the end-user to purchase a card at retail and use a hidden number to replenish his or her account. Other prepaid account funds transfer systems are well known, for example, with respect to prepaid cellular phones, and are equally applicable in this business model.

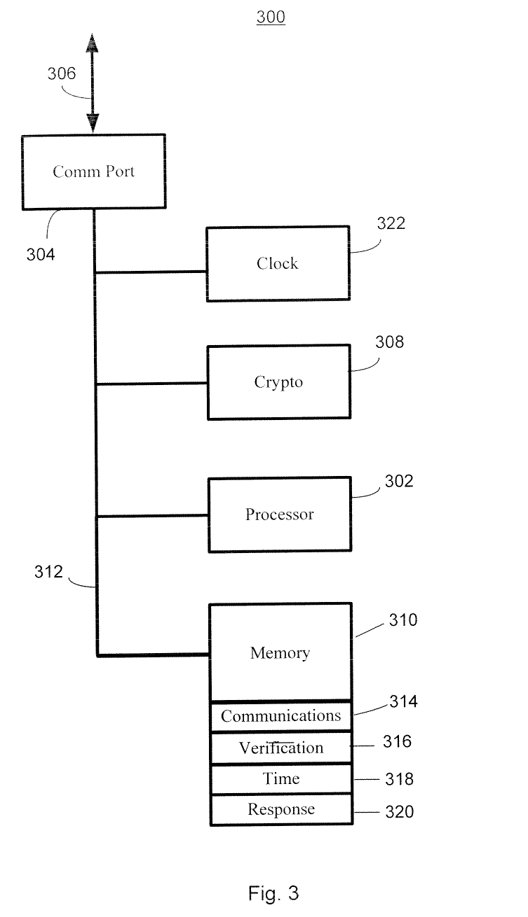

FIG. 3 is a simplified and representative block diagram of a provisioning server 300 adapted for use in a system supporting pay-per-use and subscription usage of a computer or other electronic device 204. The provisioning server 300 may include a processor 302, a communication port 304 coupled to a network 306, an optional cryptographic unit 308, and a memory 310. These elements of the provisioning server 300 may be connected by a system bus 312. The memory 310 may include both volatile and nonvolatile computer-readable memory and may store temporary data, persistent data, and computer-executable code. Executable code may include a communications module 314, a verification module 316, a time module 318, and a response module 320.

A clock 322 may be used to generate a reference time, used to compare the accuracy of clocks of metered-use electronic devices 204 206 in the domain of the provisioning server 300. In other embodiments, an external clock source may be used, for example, a global positioning satellite (GPS) receiver or the U.S. National Institute of Standards and Technology (NIST).

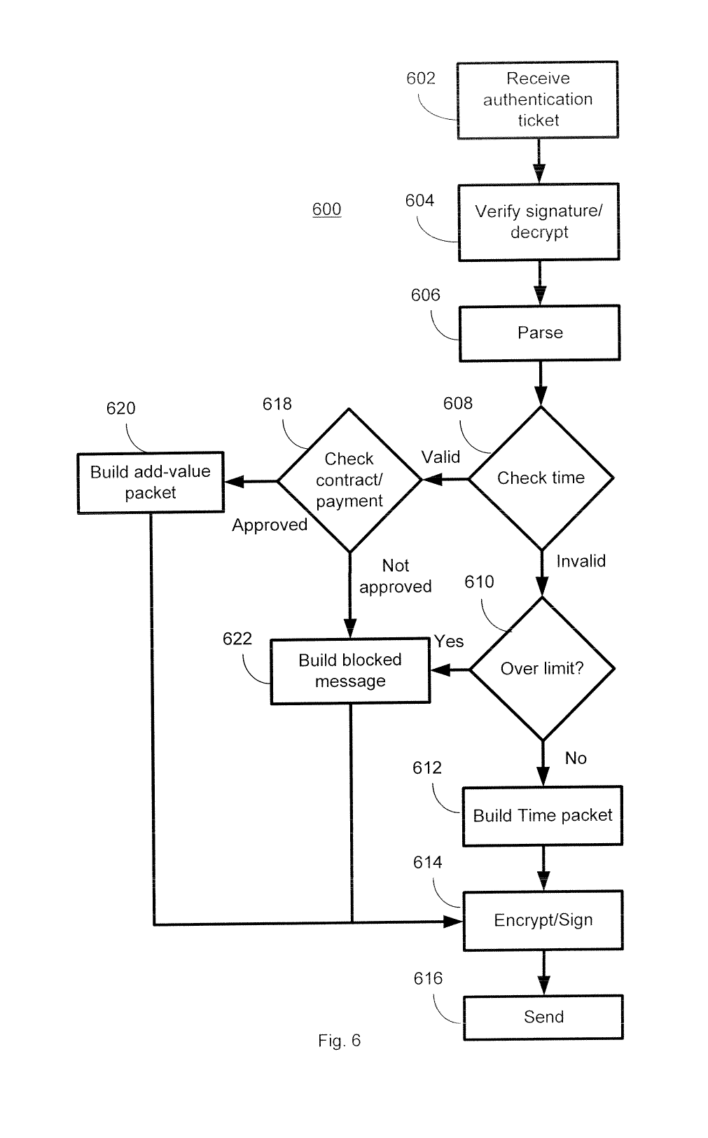

Operation of the provisioning server 300 is discussed in more detail with respect to a method described in FIG. 6. Briefly, the provisioning server 300 accepts an authentication ticket, or request, from a metered use electronic device 204 and determines whether to process the request or reply with related information or instructions.

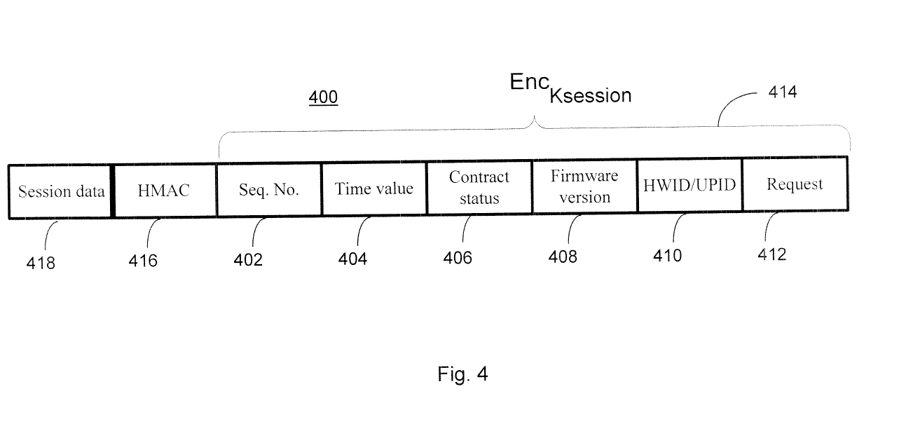

FIG. 4 is an exemplary packet format for an authentication ticket 400 sent from an electronic device, such as electronic device 204 to a provisioning server, such as provisioning server 202 from FIG. 2 or provisioning server 300) of FIG. 3). An authentication ticket 400 may include a sequence number 402, a time value 404, contract status 406, a firmware version number 408, a hard ware identifier or universal product identifier 410, and a request 412.

The sequence number 402, as known in the art, is a number with an increasing value that may be used to prevent replay of a previous authentication ticket. Each time the authentication ticket 400 is generated, the value of the previous sequence number is increased and included in the authentication ticket 400. When a provisioning server 202 receives the authentication ticket 400 it may compare the sequence number 402 to a previously received sequence number. If the sequence number 402 is the same or less than the previously received sequence number, the authentication ticket 400 may be rejected. Some embodiments may use a timestamp instead of a sequence number for replay attack mitigation.

The time value 404 may be a time read from a clock, such as a secure clock 126 of FIG. 1, when the authentication ticket 400 is being generated. This time will be compared to a reference time at the provisioning server 202. Some variation may occur because of latency in completing the assembly of the authentication ticket 400 and transmission time variability. However, because accuracy of the clock 126 is more important than synchronization with the reference time, a margin of error between the clock in the reference time may be allowed to be fairly large, on the order of hours in some embodiments. In one embodiment, a clock error for an individual electronic device may be stored at the provisioning server 202 and as long as the error remains relatively consistent, adjustments may not be required.

Contract status 406 may include either usage time left in a prepaid implementation or a subscription end date. Either value may be used to determine fraudulent behavior. For example, if usage time left exceeds a previous usage time plus any purchases, it may be implied that a usage balance in the electronic device 204 may have been tampered with.

Firmware version 408 may be used to determine if a firmware update is required. A hardware ID or universal product identifier 410 may be used as a reference for maintaining account balance information and tracking contract status. The request 412 may relate to the reason for sending the authentication ticket 400. For example, the request may be a request for additional time, a check on firmware version, or may simply be a mandatory check-in when other communication has not occurred during a specified period.

Data from the authentication ticket 400 may be encrypted with the session key as indicated by brace 414. In one embodiment, the encrypted result may be signed and hashed to generate an H MAC 416 that is then added to the authentication ticket 400. In another embodiment, the SU MAC 416 may be generated before encryption of the authentication ticket data with the session key. The process for generating an HMAC is well documented in public literature. Other message authentication code (MAC) techniques are known and may be used in other embodiments. Additional information such as tag-length-value information, XML or another descriptive language may be used to identify the various data elements may be stored in a header using an agreed to format. Header information is well known and not depicted. Additional information 418 may also be included for use in session key generation, such as a random number, key version, or hardware identifier.

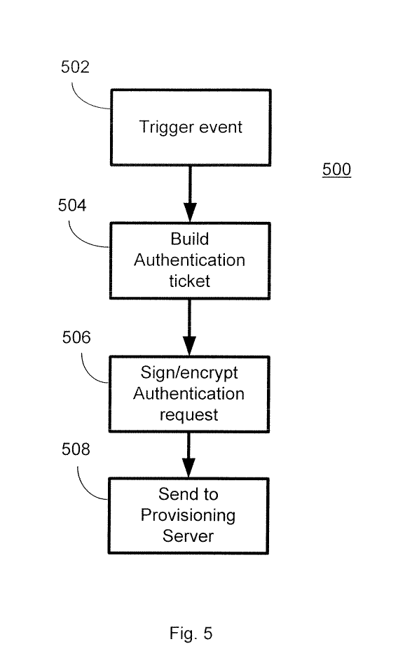

FIG. 5 is flow chart depicting an exemplary method 500 of building and sending an authentication ticket 400 at a metered-use electronic device, such as electronic device 204. At block 502, a trigger event may occur to cause the electronic device 204 to request information or services from a provisioning server 202. The trigger event may be generated by the secure module 125, by the operating system 134, an application program 135, the BIOS 133, or a utility 136. In one embodiment, the operating system may be aware of subscription or metered usage time status and at a low-water mark may initiate the communication with the provisioning server 202. In another embodiment, the security module 125 may recognize the low-water mark or may determine that more than an allowable time has passed since a previous communication with the provisioning server 202, and generate the trigger event.

At block 504, an authentication ticket 400 may be constructed using locally available data, some of which may be supplied by the security module 125, such as sequence number 402, time value 404, contract status 406, and firmware version 408. At block 506, the security module 125 may generate a session key, for example, a session key based on an internally stored symmetric key, a random number, and the sequence number 402. Of course, numerous protocols exist for generation of a session key, including use of a Diffie-Hellman key exchange, and any such protocol should produce acceptable results. The authentication ticket payload, for example data 414 from FIG. 4, may be signed and encrypted, with an HMAC 416 used in one embodiment. As above, many encryption and signature protocols are known and produce acceptable results with respect to this process. As is known the art, separate signing and encryption keys may also be used. At block 508, after the authentication ticket has been generated, encrypted, and signed, it may be sent to the provisioning server 202 over any available network, such as wide-area network 208. In one embodiment, where network access may be limited, the authentication ticket may be stored on a floppy disk or other removable media and hand carried to a service center for further processing.

FIG. 6 is an exemplary method 600 of processing an inbound transmission containing an authentication ticket at a provisioning server, such as provisioning server 202. At block 602, the authentication ticket 400 may be received from an electronic device 204, either via a network connection 208 or via removable media, for example, communications module 314 stored in memory 310 of FIG. 3. A block 604, the authentication ticket 400 may be decrypted and its signature verified, for example, using the verification module 316 of FIG. 3, after generation of session keys using either in-band or out-of-band information. Assuming the verification process passes at block 604, the authentication ticket may be parsed into its various elements, for example, using header information known in the art and not depicted in FIG. 4. It is worth noting that because the encryption and signing process may be transacted at the application level between the security module 125 and the provisioning server 202, that neither the operating system 134 of the electronic device 204 nor the transport mechanism 208 may have access to the data of the authentication ticket 400.

At block 608, the time value 404 may be compared to a reference time, for example, time at clock 322, using the time module 318 of FIG. 3. When the time verification fails, the “invalid” branch from block 608 may be followed to block 610. At block 610, a determination may be made as to whether this particular electronic device 204 has previously submitted authentication tickets 400 with invalid time values. If not, the “no” branch from block 610 may be taken to block 612 and a time packet for use in correcting the electronic device 204 local time may be built using the current reference time of clock 322. The time packet, and other responses, may be built by the response module 320 of FIG. 3. At block 614, the time packet may be encrypted and signed, for example in one embodiment, using the same session keys as the inbound transmission. At block 616, the time packet may be sent to the electronic device 204.

If, at block 610, the number of invalid submissions exceeds an allowable limit, for example, three, the “yes” branch from block 610 may be taken to block 622 and a block message may be constructed to alert the electronic device 204, or at least a security module 125 of the electronic device 204, that an error condition persists at the electronic device 204. The blocked message 622 may be signed and encrypted at block 614 and sent to the electronic device 204 at block 616. In other embodiments, the blocked message may be sent in the clear when no private data is incorporated in the message.

If, at block 608, the comparison of time value 404 and the reference time from clock 322 is within a threshold margin, the “valid” branch from block 608 may be taken to block 618. At block 618, if the request is for an add-value transaction, a user account may be checked to determine whether sufficient funds are available for the add-value transaction for example, by checking with accounting server 210 of FIG. 2. Other request types, such as a periodic check-in message may also require checking with the accounting server 210. If the requested transaction is approved, the “approved” branch from block 618 may be taken to block 620 and an add-value message may be built incorporating information used by the security module 125 to locally re-provision an appropriate metering apparatus in the security module 125. The message may be signed and encrypted at block 614 and, at block 616, sent to the electronic device 204.

If, at block 618, the requested transaction is denied, the “not approved” branch from block 618 may be followed to block 622 and an appropriate blocked message may be constructed and, at block 614, encrypted and signed. At block 616, the blocked message may be sent to the electronic device 204.

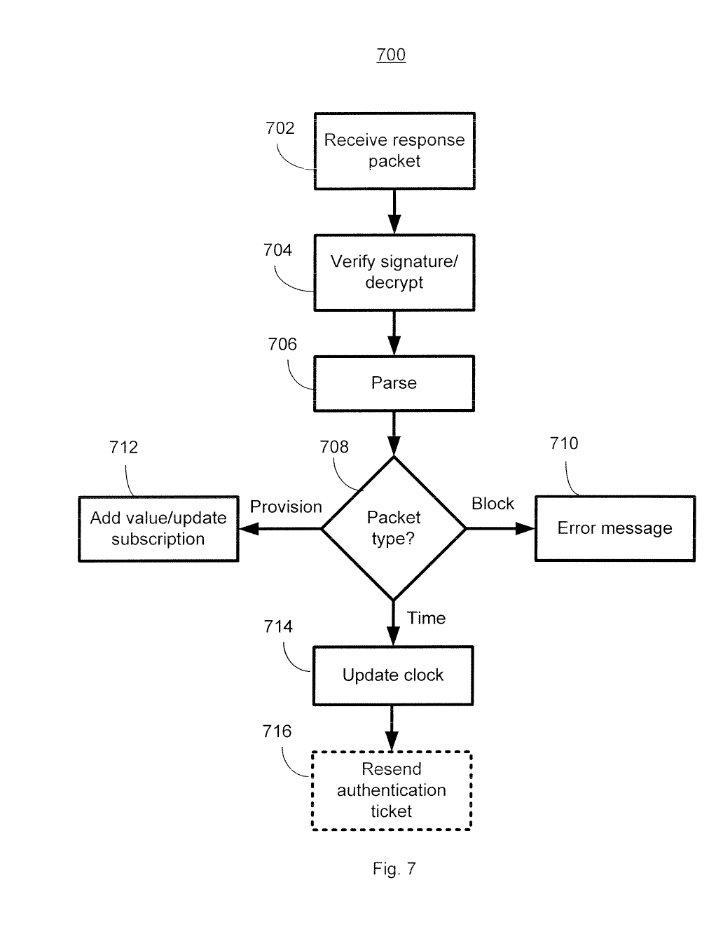

FIG. 7 is an exemplary method 700 of processing a response to an authentication ticket at a metered-use device, such as electronic device 204. At block 702, the electronic device 204 may receive the response packet from the provisioning server 202. At block 704, the signature may be verified and the response decrypted, in one embodiment using the same session keys as used for the original message. At block 706, the response may be parsed into various components and a packet type determined at block 708.

If, at block 708 the message is determined to be a block message, the “block” branch may be followed to block 710 and an appropriate error message generated or other appropriate action taken related to account balance or clock 126 problems. In one embodiment, the security module 125 may force the electronic device 204 into a limited operating mode until restored by an authenticated message.

If, at block 708, the response contains a provisioning packet, the “provision” branch may be followed to block 712 and an add-value transaction generated within the security module 125 to increase usage time or update a subscription end date, as appropriate

If, at block 708, the response contains a time message, the “time” branch from block 708 may be taken to block 714, and the security module 125 may update its clock 126 in accordance with the time contained in the time message. As mentioned above, because of transmission and processing delays, the time at clock 126 may not be synchronized with clock 322 of the provisioning server 202, but merely needs to maintain consistent time over the usage or subscription period.

The mandatory inclusion of a local time in each transmission to a provisioning server provides a valuable tool for enforcement of contractual terms in a metered-use electronic device. As opposed to expiration times used in Internet protocol and other data transport mechanisms, inclusion of local time in an encrypted transmission payload is not used for routing priority or to drop expired transmission packets. Rather, the local time values incorporated in the encrypted transmission payload are used as a simple check to determine whether tampering or other hardware problems may be occurring at a metered-use electronic device. Also in contrast to expiration times used in Internet protocol and other transport mechanisms, strict synchronization of clocks is not required and the cost associated with clock synchronization may be avoided. This method of validating time as part of other data transmissions and the associated method of resynchronization provides system operators and underwriters a simple and effective tool for the administration of occasionally-connected electronic devices.

Although the foregoing text sets forth a detailed description of numerous different embodiments of the invention, it should be understood that the scope of the invention is defined by the words the claims set forth at the end of this patent. The detailed description is to be construed as exemplary only and does not describe every possible embodiment of the invention because describing every possible would be impractical, if not impossible. Numerous alternative embodiments could be implemented, using either current technology or technology developed after the filing date of the patent, which would still fall within the scope of the claims defining the invention.

Thus, many modifications and variations may be made in the techniques and structures described and illustrated herein without departing from the spirit and the scope of the present invention. Accordingly, it should be understood that the methods and apparatus described herein are illustrative only and are limiting upon the scope of the invention.

We claim:

1. A method of managing time synchronization between a metered-use electronic device and a server comprising:
receiving an authentication ticket from the metered-use electronic device;
parsing the authentication ticket to extract at least a sequence number and a time value representing a UTC time at the requesting entity;
determining that the time value is valid if the time value varies from a reference time by less than an allowable limit;
sending a provisioning packet when the time value is valid; and
sending a time packet when the time value is invalid, the time packet comprising the reference time.

2. The method of claim 1 further comprising:
reviewing past authentication tickets for invalid time values; and
sending a blocked packet when a number of invalid time values in past authentication tickets exceeds a limit.

3. The method of claim 2 further comprising cryptographic authentication of one of the time packet, the provisioning packet, and the blocked packet with a session key derived from a cryptographic secret in the requesting entity, the cryptographic authentication comprising one of a message authentication code, a signature, and a hash code.

4. The method of claim 1 further comprising decrypting the authentication ticket using a session key based on a cryptographic secret in the requesting entity.

5. The method of claim 1 authentication ticket comprises one of contract status, firmware version, and universal product identifier.

6. The method of claim 5 contract status is one of metering time balance and subscription expiration date.

7. The method of claim 1 further comprising) authenticating the time packet at the requesting entity and updating the UTC time at the requesting entity in accordance with the reference time.

8. The method of claim 1 wherein the requesting entity is a security module in an electronic device, the security module adapted to govern usage of the electronic device according to contractual terms.

9. The method of claim 1 further comprising comparing the sequence number to an expected sequence number and rejecting the authentication ticket if the comparison fails.

10. A server for validating and synchronizing time on an electronic device adapted for metered-use, the server comprising:
a communication port for two-way communication;
a cryptographic unit;
a processor coupled to the port, the cryptographic unit; and
a computer-readable medium having computer-executable instructions and data, the computer-readable medium including executable modules comprising:
a communication module for sending and receiving messages between the server and the electronic device;
a verification module for routing messages through the cryptographic unit when required;
a time module for determining when a message from the electronic device contains a time value within a limit value of a reference time; and
a response module that sends a reply message to the electronic device corresponding to a signal from the time module, an electronic device account status, and an electronic device account history.

11. The server of claim 10, wherein the reply message from the response module is a time synchronization message when the time module indicates the time value is outside the limit value of the time reference.

12. The server of claim 10, wherein the reply message from the response module is a value-update message when the time module indicates the time value is within the limit value of the reference time and the electronic device account status supports a value-update transaction.

13. The server of claim 10, wherein the response module logs time synchronization messages to the electronic device.

14. The server of claim 10, w herein the reply message from the response module is a blocked message when the log of time synchronization messages indicates a threshold of consecutive time synchronization messages exceeds an allowable limit.

15. A computer-readable medium having computer-executable instructions for executing a method on a server enforce time synchronization with a remote device comprising:
receiving a signed and encrypted message from the remote device;
validating the signature;
decrypting the encrypted message to form a message;
parsing a time value from the message;
verifying the time value is within a threshold limit of a reference time;
sending a time synchronization packet to the remote device when verifying the time value is within the threshold limit fails.

16. The computer-readable medium of claim 15, wherein the method further comprises:
parsing a request for a value-add packet from the message;
building a value-add packet when a client account corresponding to the remote device meets contractual terms for a value-add packet and verifying the time value succeeds;
encrypting the value-add packet;
signing the value-add packet;
sending the value-add packet to the remote device.

17. The computer-readable medium of claim 15, wherein the method further comprises:
generating a session key based on a unique identifier for the remote device;
decrypting the encrypted message using the session key.

18. The computer-readable medium of claim 15, wherein the method further comprises:
parsing at least one of a remote device hardware identifier, a secure device version number, a sequence number, and a remote device metered-use balance.

19. The computer-readable medium of claim 15 wherein validating the signature comprises calculating a key-hash message authentication code (HMAC) for the encrypted message and validating the signature when the calculated HMAC matches an HMAC accompanying the encrypted message.

20. The computer-readable medium of claim 15, wherein the threshold limit of reference time is between one minute and one hour.
